(19) United States
(12) Patent Application Publication
(10) Pub. No.: US 2011/0105313 A1
(43) Pub. Date: May 5, 2011

(54) USE OF SULPHUR-CONTAINING SUPPORTS FOR CATALYTIC REFORMING

(75) Inventors: Yohan Oudart, Pantin (FR); Sylvie Lacombe, Vernaison (FR); Herve Cauffriez, Charly (FR); Pierre-Yves LE-Goff, Brunstatt (FR); Renaud Revel, Serpaize (FR)

(73) Assignee: IFP Energies nouvelles, RUEIL-MALMAISON CEDEX (FR)

(21) Appl. No.: 12/996,039

(22) PCT Filed: May 20, 2009
(86) PCT No.: PCT/FR2009/000605

§ 371 Date: Dec. 3, 2010

(30) Foreign Application Priority Data
Jun. 6, 2008 (FR) 08/03176

(51) Int. Cl. B01J 27/02; B01J 37/18; B01J 37/08; B01J 27/187; B01J 21/04

(52) U.S. Cl. 502/213; 502/223; 502/221; 502/220; 502/439

(57) ABSTRACT

The invention concerns a process for preparing a catalyst comprising at least one metal from group VIII, rhenium or iridium and a sulphur-containing support, said catalyst having a sodium content which is strictly less than 50 ppm by weight and a sulphur content in the range 1500 to 3000 ppm by weight. The invention also concerns the use of said catalyst in a catalytic reforming reaction.

Catalysts for reforming gasoline and/or for producing aromatics are bifunctional catalysts, i.e. they are constituted by two phases, one being metallic and one being acidic, which play a well-defined role in the activity of the catalyst. The metallic function provides for dehydrogenation of naphthenes and paraffins and for hydrogenation of coke precursors. The acidic function provides for isomerization of naphthenes and paraffins and for the cyclization of paraffins. The acidic function is supplied by the support itself, usually a halogenated alumina. The metallic function is generally provided by a noble metal from the platinum family and at least one promoter metal, principally tin for the continuous process and rhenium in the semi-regenerative process. The metallic and acidic phases may be promoted by various dopants.

Generally, the support for the catalysts used is gamma alumina. The support is generally in the form of beads or extrudates depending on the process. It is generally manufactured from a boehmite gel. When the gel is calcined at a certain temperature, it is transformed into gamma alumina. Boehmite may have a variety of compositions. It principally comprises aluminium and also comprises impurities in varying quantities.

The majority of boehmite gels used in reforming are of high purity. As a result, the boehmite gel is thus washed intensely in order to remove certain impurities such as sulphur or sodium, or it may be of high purity at the outset, depending on the process employed.

In the case of catalysts containing a highly hydrogenolyzing metallic function, such as rhenium or iridium, sulphur is added to the catalyst after depositing the metals, for example at the end of the reduction step, or before or during injection of the hydrocarbon feed to be converted, with the aim of calming down the very intense hydrogenolyzing function of the metal or metals.

The present application proposes a method for preparing a support comprising sulphur, said support being used to prepare reforming catalysts, preferably in a fixed bed. This support may be synthesized from aluminium sulphate and sodium aluminate. The metallic phase comprises at least one metal from group VIII, preferably platinum, and at least one promoter selected from the group constituted by rhenium and iridium. Preferably, the promoter is at least rhenium. The catalysts may optionally contain at least one dopant.

The catalyst of the invention does not need to be sulphurized before the test, because of the low hydrogenolyzing activity at the start of the test. The catalyst sulphurization step is thus dispensed with, providing a cost saving.

The support prepared in accordance with the invention generally also comprises more than 100 ppm of sodium. In prior art patents, sodium is generally eliminated from the support by washing the gel intensely. In accordance with the present invention, the sodium is exchanged during the metal impregnation step and its final content is strictly below 50 ppm by weight. The washing steps are thus reduced, providing a cost saving.

It has been observed that the initial catalytic performance of the catalysts of the invention is improved compared with prior art catalysts obtained from a pure alumina gel which has been sulphurized at the end of the preparation step or before injecting the feed to be converted.

### PRIOR ART

Patent U.S. Pat. No. 5,562,817 describes the preparation of a reforming catalyst on a support produced by reaction between aluminium sulphate and aluminium hydroxide or carbonate. The platinum/rhenium catalysts are sulphurized with hydrogen sulphide before being used. Our invention is principally distinguished by the fact that it is not necessary to sulphurize the catalyst during a specific step.

Patent GB-607 256 describes the use of a supported catalyst having dehydrogenating properties. That catalyst is obtained by hot mixing a metallic oxide having dehydrogenating properties with a hydrated aluminium sulphate. The sulphur is then completely removed by a reducing heat treatment. The catalyst preparation method of the invention does not include a reducing heat treatment in order to remove the sulphur. That heat treatment is expensive both as regards energy and as regards raw materials.

### BRIEF DESCRIPTION OF THE INVENTION

The invention concerns a process for preparing a catalyst comprising at least one metal from group VIII, rhenium or iridium and a sulphur-containing support, said catalyst having a sodium content which is strictly less than 50 ppm by weight and a sulphur content in the range 1500 to 3000 ppm by weight. The invention also concerns the use of said catalyst in a catalytic reforming reaction.

### DETAILED DESCRIPTION OF THE INVENTION

The invention concerns a process for preparing a catalyst comprising at least one metal from group VIII, preferably platinum, rhenium or iridium, preferably rhenium, a sulphur-containing support, and optionally at least one dopant selected from the group formed by gallium, germanium, indium, tin, antimony, thallium, lead, bismuth, titanium, chromium, manganese, molybdenum, tungsten, rhodium, zinc and phosphorus, said catalyst having, at the end of step d), a sodium content which is strictly less than 50 ppm by weight, preferably strictly less than 40 ppm by weight, and a sulphur content in the range 1500 to 3000 ppm by weight, preferably in the range 1550 to 2900 ppm by weight, and highly preferably in the range 1600 to 2500 ppm by weight.

The process comprises steps a), b), c) and d) detailed below:
a step a) for preparing a sulphur-containing support, comprising the following sub-steps:
a1) simultaneously adding an aqueous solution of aluminium sulphate to a basic aqueous solution of sodium aluminate in order to precipitate the alumina precursor and to form a slurry, the pH being maintained between 6 and 10, preferably in the range 8 to 10; the rate of addition of the two solutions is maintained in order to form an intermediate alumina precursor in the form of boehmite-pseudoboehmite;
a2) maturing the slurry obtained at the end of step a1) at temperatures in the range 60° C. to 250° C., preferably in the range 60° C. to 170° C., for a period of 0 to 24 h, preferably 10 min to 3 h. The pH during said step is adjusted to between 8.5 and 10, preferably between 9 and 9.5;
a3) filtering the slurry to obtain a filtration cake which is washed until the sulphur content is in the range 1500 to 3000 ppm by weight with respect to the calcined alumina;
a4) drying the filtration cake obtained at the end of step a3) between 40° C. and 150° C., preferably between 70° C. and 120° C.;
a5) forming the dry cake in order to obtain the sulphur-containing support, then calcining between 500° C. and 830° C., preferably between 550° C. and 750° C.;
a step b) for bringing the sulphur-containing support into contact with an aqueous or organic solution of at least one precursor of the metal from group VIII;
a step c) for bringing the support obtained at the end of step b) into contact with an aqueous or organic solution of at least one precursor of rhenium or iridium;
a step d) for drying the support obtained at the end of step c) at a temperature in the range 80° C. to 150° C., then calcining in air at a temperature in the range 300° C. to 600° C., then reducing in hydrogen.

The support may be obtained by forming the dry cake using any technique which is known to the skilled person. Forming may be carried out, for example, by extrusion, pelletization, by the oil drop method, by rotating plate granulation or using any other method which is well known to the skilled person.

The specific surface area is adjusted either using the calcining step and/or the maturation step to a value in the range 150 to 400 m²/g, preferably in the range 150 to 300 m²/g, and more preferably in the range 160 to 230 m²/g.

In one technique in accordance with the invention, the support undergoes impregnation using an aqueous or organic solution of at least one precursor of rhenium or iridium, the volume of the solution preferably being equal to the retention volume of the support or in excess with respect to said volume. The solid and the impregnation solution are left in contact for several hours. The solid is then washed and filtered.

The solid obtained is then impregnated using an aqueous or organic solution of at least one precursor of the selected dopant or dopants, the volume of the solution preferably being equal to the retention volume of the support or in excess with respect to said volume. The solid and the impregnation solution are again left in contact for several hours. The solid is then washed and filtered.

The solid obtained is then impregnated using an aqueous or organic solution of at least one precursor of the group VIII metal, the volume of the solution preferably being equal to the retention volume of the support or in excess with respect to said volume. After several hours contact, the product obtained is dried at a temperature in the range 80° C. to 150° C., then calcined in air between 300° C. and 600° C., preferably by flushing in air for several hours.

The order of the steps for impregnating the promoter, dopant and noble metal may be reversed. Said steps may be carried out in any order. The washing steps may optionally be carried out before each new impregnation step. At least one impregnation step must be carried out with a volume of impregnation solution which is in excess with respect to the retention volume of the support.

The impregnation solutions may optionally contain one or more acids in low concentration, such as nitric, carbonic, sulphuric, citric, formic or oxalic acid, in order to improve the distribution of the noble metal or metals and/or the promoter or promoters.

The dopant or dopants may also be introduced during synthesis of the alumina or during forming of the catalyst. Thus, at least one dopant selected from the group constituted by gallium, germanium, indium, tin, antimony, thallium, lead, bismuth, titanium, chromium, manganese, molybdenum, tungsten, rhodium, zinc and phosphorus may be introduced during step a1) or during step a5).

In the case in which the noble metal is platinum, the platinum precursors form part of the following group, this list not being limiting: hexachloroplatinic acid, bromoplatinic acid, ammonium chloroplatinate, chlorides of platinum, platinum dichlorocarbonyl dichloride, platinum tetraamine chloride. Organic complexes of platinum, such as platinum (II) diacetylacetonate, may also be used. Preferably, the precursor used is hexachloroplatinic acid.

In the case of a dopant, nitrate, halide or organometallic type precursors may be used; this list is not limiting.

In the case in which rhenium is used as the promoter, the precursors such as perrhenic acid or ammonium or potassium perrhenate may be used; this list is not limiting.

When the various precursors used in the preparation of the catalyst of the invention do not contain halogen or contain halogen in insufficient quantity, it may be necessary to add a halogenated compound during preparation. Any compound which is known to the skilled person may be used and incorporated in any of the steps for preparing the catalyst of the invention. In particular, it is possible to use organic compounds such as methyl or ethyl halides, for example dichloromethane, chloroform, dichloroethane, methylchloroform or carbon tetrachloride.

The halogen may also be added by impregnation with an aqueous solution of the corresponding acid, for example hydrochloric acid, at any time during the preparation. A typical protocol consists of impregnating the solid in order to introduce the desired quantity of halogen. The catalyst is kept in contact with the aqueous solution for a period which is sufficiently long to deposit this quantity of halogen.

The chlorine may also be added to the catalyst of the invention by means of an oxychlorination treatment. Such a treatment may, for example, be carried out between 350° C. and 550° C. for several hours in a flow of air containing the desired quantity of chlorine and possibly containing water.

Before use, the catalyst undergoes a treatment in hydrogen in order to obtain an active metallic phase. The procedure for this treatment consists, for example, of slowly raising the temperature in a stream of hydrogen to the maximum reduction temperature which is, for example, in the range 100° C. to 600° C., and preferably in the range 200° C. to 580° C., followed by holding at this temperature for 30 minutes to 6 hours, for example. This reduction may be carried out immediately after calcining or later at the point of use. It is also possible to reduce the dried product directly at the point of use.

The support for the catalyst of the invention has a specific surface area in the range 150 to 400 m²/g, preferably in the range 150 to 300 m²/g, and more preferably in the range 160 to 230 m²/g.

The metallic phase of the catalyst of the invention comprises at least one noble metal, preferably platinum, and at least one promoter selected from the list defined by rhenium and iridium. Preferably, the promoter is at least rhenium. The catalyst generally comprises at least one dopant, selected from the group formed by gallium, germanium, indium, tin, antimony, thallium, lead, bismuth, titanium, chromium, manganese, molybdenum, tungsten, rhodium, zinc and phosphorus. Preferably, the dopant or dopants are selected from the group formed by gallium, germanium, indium, tin, bismuth and phosphorus.

The catalyst generally comprises a halogen selected from the group formed by chlorine, fluorine, bromine and iodine. Preferably, the halogen is chlorine.

The quantity of noble metal in the catalyst of the invention is in the range 0.02% to 2% by weight, preferably in the range 0.05% to 1.5% by weight, more preferably in the range 0.1% to 0.8% by weight. The quantity of each promoter, rhenium or iridium, in the catalyst of the invention is in the range 0.02% to 10% by weight, preferably in the range 0.05% to 2% by weight, more preferably in the range 0.1% to 1% by weight. The quantity of each dopant element is in the range 0 to 2% by weight, preferably in the range 0 to 1% by weight, more preferably in the range 0 to 0.7% by weight. The quantity of halogen is in the range 0.1% to 15% by weight, preferably in the range 0.1% to 10% by weight, and more preferably in the range 0.1% to 5% by weight. Highly preferably, the halogen is chlorine, and in this case the catalyst of the invention highly preferably contains in the range 0.5% to 2% by weight of chlorine.

The catalyst in the bed is in the form of particles which may be beads, extrudates, which may be polylobed, pellets or any other routinely used form. Preferably, the catalyst is in the form of extrudates.

In accordance with the invention, the catalyst described above is used in processes for reforming gasoline and for producing aromatics, preferably employing fixed beds.

The typical feed which is treated comprises paraffinic, naphthenic and aromatic hydrocarbons containing 5 to 12 carbon atoms per molecule. This feed is defined, inter alia, by its density and its composition by weight. This feed is brought into contact with the catalyst of the present invention at a temperature in the range 300° C. to 700° C., preferably in the range 350° C. to 550° C. The mass flow rate of the feed treated per unit mass of catalyst may be from 0.1 to 10 kg/(kg.h), preferably in the range 0.5 to 6 kg/(kg.h). The operating pressure may be fixed between atmospheric pressure and 4 MPa, preferably in the range 1 MPa to 3 MPa. A portion of the hydrogen produced is recycled in order to reach a molar ratio of recycled hydrogen to hydrocarbon feed in the range 0.1 to 10, preferably in the range 1 to 8.

The following examples illustrate the invention without limiting its scope.

### EXAMPLES

### Example 1

### (Not in Accordance with the Invention): Preparation of Catalyst A

The support was a gamma alumina with a specific surface area of 215 m² per gram which contained less than 20 ppm by weight of elemental sulphur (X ray fluorescence detection limit) and less than 20 ppm by weight of sodium (atomic absorption detection limit).

100 g of support was brought into contact with 500 cm³ of an aqueous solution of hydrochloric acid and hexachloroplatinic acid comprising 0.30 g of platinum. The quantity of hydrochloric acid was adjusted in order to have a chlorine content of close to 1% by weight in the final catalyst. The impregnation solution was then withdrawn.

300 cm³ of an aqueous solution comprising 0.86 g of rhenium introduced in the form of ammonium perrhenate was brought into contact with the support comprising platinum obtained at the end of the preceding step for 3 hours.

The catalyst obtained was dried for 1 hour at 120° C., calcined for 2 hours at 500° C., then reduced in hydrogen for 2 hours at 520° C.

The catalyst was then sulphurized with a hydrogen/H₂S mixture (2660 ppm by weight of H₂S) for 7 minutes at 500° C. (flow rate: 220 cm³/min under NTP conditions).

The final catalyst contained 0.29% by weight of platinum, 0.42% by weight of rhenium, 1.05% by weight of chlorine and 1620 ppm by weight of sulphur.

### Example 2

### (In Accordance with the Invention): Preparation of Catalyst B

The support was a gamma alumina with a specific surface area of 206 m² per gram obtained by simultaneously adding a solution of aluminium sulphate to a solution of sodium aluminate at a pH of 9. The slurry was then maintained at pH 9 for the 3 hours of maturation. It was then filtered, washed, spray dried, extruded, dried at 100° C. and calcined at 720° C. Washing was carried out before extrusion such that the support contained 1690 ppm by weight of sulphur and 504 ppm by weight of sodium after calcining.

100 g of this support was brought into contact with 500 cm³ of an aqueous solution of hydrochloric acid and hexachloroplatinic acid comprising 0.30 g of platinum. The quantity of hydrochloric acid was adjusted in order to have a chlorine content of close to 1% by weight in the final catalyst. The impregnation solution was then withdrawn.

300 cm³ of an aqueous solution comprising 0.86 g of rhenium introduced in the form of ammonium perrhenate was brought into contact with the support comprising platinum obtained at the end of the preceding step for 3 hours.

The catalyst obtained was dried for 1 hour at 120° C., calcined for 2 hours at 500° C., then reduced in hydrogen for 2 hours at 520° C.

The final catalyst contained 0.29% by weight of platinum, 0.43% by weight of rhenium, 1.08% by weight of chlorine, 1650 ppm by weight of sulphur and 24 ppm by weight of sodium.

### Example 3

### (Not in Accordance with the Invention): Preparation of Catalyst C

The support was a gamma alumina with a specific surface area of 195 m² per gram obtained by simultaneously adding a solution of aluminium sulphate to a solution of sodium aluminate at a pH of 9. The slurry was then maintained at pH 9 for the 3 hours of maturation. It was then filtered, washed, spray dried, extruded, dried at 100° C. and calcined at 740° C. Washing was controlled so that this support contained 1260 ppm by weight of sulphur and 504 ppm by weight of sodium.

20 g of this support was brought into contact with 100 cm³ of an aqueous solution of hydrochloric acid and hexachloroplatinic acid comprising 0.06 g of platinum. The quantity of hydrochloric acid was adjusted in order to have a chlorine content of close to 1% by weight in the final catalyst. The impregnation solution was then withdrawn.

60 cm³ of an aqueous solution comprising 0.17 g of rhenium introduced in the form of ammonium perrhenate was brought into contact with the support comprising platinum obtained at the end of the preceding step for 3 hours.

The catalyst obtained was dried for 1 hour at 120° C., calcined for 2 hours at 500° C., then reduced in hydrogen for 2 hours at 500° C.

The final catalyst contained 0.28% by weight of platinum, 0.41% by weight of rhenium, 0.96% by weight of chlorine, 1250 ppm by weight of sulphur and 22 ppm by weight of sodium.

### Example 4

### (Not in Accordance with the Invention): Preparation of Catalyst D

The support was a gamma alumina with a specific surface area of 222 m² per gram obtained by simultaneously adding a solution of aluminium sulphate to a solution of sodium aluminate at a pH of 9. The slurry was then maintained at pH 9 for the 3 hours of maturation. It was then filtered, washed, spray dried, extruded, dried at 100° C. and calcined at 690° C. Washing was controlled so that this support contained 3490 ppm by weight of sulphur and 611 ppm by weight of sodium.

20 g of this support was brought into contact with 100 cm³ of an aqueous solution of hydrochloric acid and hexachloroplatinic acid comprising 0.06 g of platinum. The quantity of hydrochloric acid was adjusted in order to have a chlorine content of close to 1% by weight in the final catalyst. The impregnation solution was then withdrawn.

60 cm³ of an aqueous solution comprising 0.17 g of rhenium introduced in the form of ammonium perrhenate was brought into contact with the support comprising platinum obtained at the end of the preceding step for 3 hours.

The catalyst obtained was dried for 1 hour at 120° C., calcined for 2 hours at 500° C., then reduced in hydrogen for 2 hours at 520° C.

The final catalyst contained 0.30% by weight of platinum, 0.42% by weight of rhenium, 1.12% by weight of chlorine, 3460 ppm by weight of sulphur and 28 ppm by weight of sodium.

### Example 5

### Catalytic Tests

Catalysts A, B, C and D were tested for the transformation of a naphtha type hydrocarbon feed derived from oil distillation which had the following characteristics:

| | | |
|---|---|---|
| Density at 15° C. | 0.759 | kg/dm³ |
| Mean molecular weight | 119 | g |
| Paraffins/naphthenes/aromatics | 53/31/16 | % by weight |

This transformation was carried out in a traversed bed pilot test unit in the presence of hydrogen. Before injecting the feed, the catalysts were activated at high temperature in hydrogen for 2 hours. The test was carried out using the following operating conditions:

| | |
|---|---|
| Total pressure: | 1.5 MPa |
| Feed flow rate: | 2 kg per kg of catalyst per hour |
| Research octane number: | 98 |
| Molar ratio, recycled hydrogen to | 2.5 |
| hydrocarbon feed: | |

The performances obtained after 40 h of operation are recorded in Table 1, namely the temperature necessary to attain the envisaged research octane number, representative of the catalyst activity, and the yields by weight of C₅⁺ (hydrocarbons containing at least 5 carbon atoms) and C₄⁻ (hydrocarbons containing 1 to 4 carbon atoms) reformate, representative of the selectivity of the catalyst.

TABLE 1

| | Temperature | C₅⁺ Yield | C₄⁻ Yield |
|---|---|---|---|
| Sample | (° C.) | (wt %) | (wt %) |
| A | 490 | 87.3 | 9.9 |
| B | 478 | 87.8 | 9.4 |
| C | 483 | 86.2 | 11.1 |
| D | 495 | 87.1 | 10.1 |

The two catalysts A and B had the same sulphur content. An improvement in performance as regards the activity of catalyst B (in accordance with the invention) was observed over the performance of catalyst A (not in accordance with the invention from the point of view of preparation of the catalyst). Further, introducing sulphur into the support means that the final catalyst sulphurization step can be avoided.

The performances of catalysts C and D obtained after 40 h of operation are also recorded in Table 1. Catalyst C with a sulphur content below the claimed range of contents was less selective than catalyst B of the invention. The sulphur content of catalyst D was higher than the claimed range of contents in the present patent and was less active than catalyst B of the invention.

1. A process for preparing a catalyst comprising at least one metal from group VIII, rhenium or iridium and a sulphur-containing support, said catalyst having, at the end of step d), a sodium content which is strictly less than 50 ppm by weight and a sulphur content in the range of 1500 to 3000 ppm by weight, said process comprising the following steps:
a step a) for preparing a sulphur-containing support, comprising the following sub-steps:
a1) simultaneously adding an aqueous solution of aluminium sulphate to a basic aqueous solution of sodium aluminate in order to precipitate an alumina precursor and to form a slurry, the pH being maintained between 6 and 10, the rate of addition of the two solutions being maintained in order to form an intermediate alumina precursor in the form of boehmite-pseudoboehmite;
a2) maturing the slurry obtained at the end of step a1) at temperatures in the range of 60° C. to 250° C. for a period of 0 to 24 h, the pH during said step being adjusted to between 8.5 and 10;
a3) filtering the slurry obtained at the end of step a2) to obtain a filtration cake which is washed until the sulphur content is in the range of 1500 to 3000 ppm by weight with respect to ultimately calcined alumina;
a4) drying the filtration cake obtained at the end of step a3) between 40° C. and 150° C.;
a5)forming the dry cake obtained at the end of step a4) in order to obtain the sulphur-containing support then calcining between 500° C. and 830° C.;
a step b) of bringing the sulphur-containing support obtained at the end of step a) or step c) into contact with an aqueous or organic solution of at least one precursor of the metal from group VIII;
a step c) of bringing the support obtained at the end of step b) or step a) into contact with an aqueous or organic solution of at least one precursor of rhenium or iridium;
a step d) for drying the support obtained at the end of step c) at a temperature in the range of 80° C. to 150° C., then calcining in air at a temperature in the range of 300° C. to 600° C., then reducing in hydrogen.

2. A process for preparing a catalyst according to claim 1, in which the group VIII metal is platinum.

3. A process for preparing a catalyst according to claim 2, in which the platinum precursor is hexachloroplatinic acid.

4. A process for preparing a catalyst according to claim 1, in which the catalyst comprises rhenium.

5. A process for preparing a catalyst according to claim 4, in which the rhenium precursor is ammonium perrhenate.

6. A process for preparing a catalyst according to claim 1, in which the sub-step a5) for drying the filtration cake obtained at the end of step a4) is carried out between 70° C. and 120° C. and calcining is carried out between 550° C. and 750° C.

7. A process for preparing a catalyst according to claim 1 having, at the end of step d), a sodium content which is strictly less than 40 ppm by weight.

8. A process for preparing a catalyst according to claim 1 having, at the end of step d), a sulphur content in the range of 1550 to 2900 ppm by weight.

9. A process for preparing a catalyst according to claim 1, further comprising a step for bringing the sulphur-containing support obtained at the end of step a), b) or c) into contact with an aqueous or organic solution of at least one precursor of a dopant or dopants selected from gallium, germanium, indium, tin, antimony, thallium, lead, bismuth, titanium, chromium, manganese, molybdenum, tungsten, rhodium, zinc and phosphorus.

10. A process for preparing a catalyst according to claim 1, comprising introducing at least one dopant selected from gallium, germanium, indium, tin, antimony, thallium, lead, bismuth, titanium, chromium, manganese, molybdenum, tungsten, rhodium, zinc and phosphorus during step a1) or during step a5).

11. A process according to claim 1, wherein the washed filtration cake contains 1600 to 2500 ppm by weight of sulphur.

12. A process for preparing a catalyst according to claim 11, in which the group VIII metal is platinum.

13. A process for preparing a catalyst according to claim 12, in which the catalyst comprises rhenium.

14. A process for preparing a catalyst according to claim 13, in which the sub-step a5) for drying the filtration cake obtained at the end of step a4) is carried out between 70° C. and 120° C. and calcining is carried out between 550° C. and 750° C.

15. A catalyst prepared by the process of claim 1.

16. A catalyst prepared by the process of claim 14.

17. A process for producing a sulfur-containing support comprising
a1) simultaneously adding an aqueous solution of aluminium sulphate to a basic aqueous solution of sodium aluminate in order to precipitate an alumina precursor and to form a slurry, the pH being maintained between 6 and 10, the rate of addition of the two solutions being maintained in order to form an intermediate alumina precursor in the form of boehmite-pseudoboehmite;
a2) maturing the slurry obtained at the end of step a1) at temperatures in the range of 60° C. to 250° C. for a period of 0 to 24 h, the pH during said step being adjusted to between 8.5 and 10;
a3) filtering the slurry obtained at the end of step a2) to obtain a filtration cake which is washed until the sulphur content is in the range of 1500 to 3000 ppm by weight with respect to ultimately calcined alumina;
a4) drying the filtration cake obtained at the end of step a3) between 40° C. and 150° C.;
a5) forming the dry cake obtained at the end of step a4) in order to obtain the sulphur-containing support then calcining between 500° C. and 830° C.

18. A support prepared according to the process of claim 17.
